(19) United States
(12) Patent Application Publication
(10) Pub. No.: US 2003/0163416 A1
(43) Pub. Date: Aug. 28, 2003

(54) Transaction information management system, transcaction information anonymizing server, and transaction information management method

(75) Inventor: Hironobu Kitajima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/197,675

(22) Filed: Jul. 18, 2002

(30) Foreign Application Priority Data
Feb. 25, 2002 (JP) 2002-047670

(51) Int. Cl. G06F 17/60

(52) U.S. Cl. 705/39

(57) ABSTRACT

A technique is provided for making a good use of the market values of purchase information while guaranteeing customers' privacy. The system includes: obtaining means, provided at a merchant, for obtaining transaction information; anonymizing means for generating anonymous transaction information that never reveals customers' identities, according to the transaction information, which has been obtained by the obtaining means; and storage means for storing the anonymous transaction information, which has been generated by the anonymizing means. The present technique is applicable to an electronic payment system employing SET.

### BACKGROUND OF THE INVENTION

1. Field of the Invention

The present invention relates to a system and a method, which are applied in an electronic payment system employing the SET™ (Secure Electronic Transaction™: a trademark owned by SET Secure Electronic Transaction LLC.) method, for managing transaction information about a commercial transaction made between a purchaser and a merchant. The invention also relates to servers used in the present system.

2. Description of the Related Art

A credit payment system for electronic payment in network commerce has been becoming increasingly popular, and an open technical standard for the commerce industry, such as SET, has already been developed and employed at online shops.

[A] Current State of Affairs of Electronic Payment:

Online shops are common today which sell products and services over a network. There are several payment methods employed in online shopping: a credit card, wire transfer, cash on delivery, and so on. Payment by credit card is the most common payment method in these days.

The credit card payment can utilize an existing payment system offered by a credit card company or the like. This payment method is advantageous in that cardholders can use their credit cards to make payment without additional costs such as commission or without any complicated procedures.

Current credit card payment systems, however, have the following problems. Card numbers and personal information are transferred online to merchants, and credit payment between the merchants and credit card companies is also carried out online, but all the data transfer among customers, merchants, and credit card companies has not yet been integrated and automated (to be performed online). The current systems still have security problems such as protection of confidential personal information and prevention of data tampering. In view of these, current credit card payment systems are not necessarily competent in today's network environments.

Therefore, major credit card companies have been playing a pivotal role in developing an open technical standard for the commerce industry as a way to facilitate electronic payment transactions. By mutual agreement among them, the SET method was employed and has now been becoming gradually widespread in the commerce industry.

Now, referring to FIG. 10, a brief description of SET is given hereinbelow.

In the electronic payment system of FIG. 10, participants in an electronic payment are a customer (sometimes also called “purchaser”), a merchant, and a credit card company. In addition, it is to be noted that the system stands on a premise that the identities of all these participants are previously confirmed by a certificate authority.

In FIG. 10, each of the purchaser, merchant, and credit company is a terminal, such as a personal computer, or a server. Such terminals and servers are communicably interconnected one another across a communications network, thereby constituting an electronic payment system in which the SET method is employed.

The electronic payment follows the following procedures (1) through (7). Note that arrows (1) through (7) in FIG. 10 denote procedures (1) though (7), respectively.

(1) A purchaser makes an order for a product or service to a merchant. An purchase order and a payment instruction are sent to the merchant in encrypted form, and the order is decrypted by the merchant.

(2) The payment instruction (containing a credit card number) is transferred to a credit card company in encrypted form.

(3) The merchant contacts the credit card company to check that the purchaser has sufficient funds or credit to make the purchase.

(4) The credit card company sends a reply message (authorization) in response to the inquiry made in the above procedure (3).

(5) Assuming the authorization in the above procedure (4) has been confirmed, the merchant delivers the purchase to the purchaser.

(6) The credit card company deposits the payment to the merchant.

(7) The credit company bills the purchaser for the payment.

The SET specifies that the foregoing are realized by using security technologies such as authorization, cryptography, digital signature, and so on. The SET realizes electronic payment in which the convenience and the security of electronic payment are balanced.

In payment following the SET, merchants are provided with only order information (the content of purchase orders), but they do not receive personal information (the content of payment instructions), such as credit card numbers. On the contrary, credit card companies have customers' personal information, but they do not receive order information. This system makes it possible to protect the customers' privacy.

[B] Current State of Affairs of Customer Information Management:

Whether a purchase is made online or non-online, customer-related information (hereinafter called customer information) that is generated at payment is being utilized in marketing research by merchants and credit card companies. Although the customer information contains many types of confidential information, an inadequacy in a legal system allows the transaction of such delicate information to go unchecked. In an extreme instance, the so-called list brokers (personal information brokers) sell such customer information partly openly.

Taking into consideration today's rising public awareness about privacy, it is difficult to believe that the current state will persist hereafter. As treaties, laws and regulations concerning privacy protection have already been framed, it is expected that an electronic payment system which realizes systematic privacy protection, such as the SET, will be diffused widely.

As is evident from the fact that such list brokers are financially viable, it appears that such customer information has market value as a variable. In particular, if a large amount of customer information is collected, it would be extremely valuable to dealer companies and various kinds of research companies. Meanwhile, if better products are developed based on marketing research conducted utilizing such an large amount of accumulated customer information, it would also benefit consumers indirectly.

The problem is that profits made from the information is exploited without being returned to customers. Another issue is that customer information is being used in marketing research without protection of the privacy of the customers. With the foregoing SET system, which has been described with reference to FIG. 10, it is indeed possible to guarantee the protection of privacy, but in that case, however, the inherent value of the customer information would come to nothing.

### SUMMARY OF THE INVENTION

With the foregoing problems in view, it is an object of the present invention to realize effective use of the market value of customer information while protecting customers' privacy in an electronic payment system which employs, for example, SET.

In order to accomplish the above object, according to the present invention, there is provided a system for managing transaction information about a commercial transaction made between a purchaser and a merchant. The system comprises: obtaining means, provided at the merchant, for obtaining the transaction information; anonymizing means for generating anonymous transaction information according to the transaction information that has been obtained by the obtaining means, which anonymous transaction information is adapted to protect the purchaser's privacy and anonymity; and storage means for storing the anonymous transaction information which has been generated by the anonymizing means.

As a preferred feature, this system further comprises a transaction-information-anonymizing server which is communicably connected, via a communications network, with the obtaining means provided at the merchant. The anonymizing means is provided at the transaction-information-anonymizing server, and the obtaining means transmits the transaction information to the anonymizing means of the transaction-information-anonymizing server via the communications network. Further, the storage means is provided at the transaction-information-anonymizing server.

As another preferred feature, the system further comprises a payment-service-providing server, communicably connected with the obtaining means provided at the merchant via a communications network, for managing payment for the transaction made between the purchaser and the merchant. The payment-service-providing server is communicably connected with the transaction-information-anonymizing server via a communications network, and the storage means is provided at the payment-service-providing server, and the generated anonymous transaction information is transmitted from the transaction-information-anonymizing server to the payment-service-providing server via the last-named communications network, and stored in the storage means of the payment-service-providing server.

As a still another preferred feature, the system further comprises a payment-service-providing server, communicably connected with the obtaining means provided at the merchant via a communications network, for managing payment for the transaction made between the purchaser and the merchant. Both of the anonymizing means and the storage means are provided at the payment-service-providing server, and the transaction information is transmitted from the obtaining means to the anonymizing means of the payment-service-providing server via the last-named communications network.

As a further preferred feature, the system further comprises a merchant server which is communicably connected with the transaction-information-anonymizing server via a communications network. The storage means is provided at the merchant server, and the generated anonymous transaction information is transmitted from the transaction-information-anonymizing server to the merchant server via the last-named communications network, and stored in the storage means of the merchant server.

As a still further preferred feature, the anonymizing means generates anonymous transaction information according to the transaction information, and the anonymous transaction information is adapted to protect not only the purchaser's but also the merchant's privacy and anonymity.

As a generic feature, there is provided a server for use in a system which manages transaction information about a commercial transaction made between a purchaser and a merchant. The server comprises: receiving means for receiving the transaction information from the merchant through a communications network; and anonymizing means for generating anonymous transaction information according to the transaction information which has been received by the receiving means. The anonymous transaction information is adapted to protect the purchaser's privacy and anonymity. As a preferred feature, the anonymizing means may generate anonymous transaction information according to the transaction information, which anonymous transaction information is adapted to protect not only the purchaser's but also the merchant's privacy and anonymity.

As still another generic feature, there is provided a method for managing transaction information about a commercial transaction made between a purchaser and a merchant. The method comprises the steps of: obtaining the transaction information; generating anonymous transaction information according to the obtained transaction information, which anonymous transaction information is adapted to protect the purchaser's privacy and anonymity; and storing and accumulating the generated anonymous transaction information.

The transaction information management system, transaction information anonymizing server, and transaction information management method of the present invention, guarantee the following advantageous results.

(1) Purchase information relating to commercial transactions between purchasers and merchants is accumulated as anonymous purchase information from which the identities of the purchasers will never be revealed, and the accumulated anonymous purchase information has great significance in marketing research (consumers' trend research) or the like. Hence if employed in an electronic payment system in combination with SET, it is possible to make the best use of the market value of the purchase information of the purchasers while protecting their privacy.

(2) An anonymization service provider having a transaction-information-anonymizing server carries out anonymization of purchase information as their business in return for payment by a party that requested the anonymization service. Further, the transaction-information-anonymizing server has a storage storing anonymous purchase information. It is thus possible for the above-mentioned anonymization service provider to effectively use the stored information for marketing research or the like, and it is also possible to provide the result of the marketing research to third parties in return for payment.

(3) A payment-service-providing server of a credit card company or a financial institution has a storage storing anonymous purchase information received from a transaction-information-anonymizing server. It is thus possible for a payment service provider, such as a credit card company or a financial institution, to effectively use the stored information for marketing research or the like, and it is also possible to provide the result of the marketing research to third parties in return for payment.

(4) Since a payment-service-providing server of a credit company or a financial institution has an anonymizing means and a storage, it is possible for the payment service provider, such as the credit card company or the financial institution, to anonymize the purchase information within its own server, without paying for the anonymization processing, and the generated anonymous purchase information is accumulated in the server. It is thus possible for the payment service provider to effectively use the accumulated information for marketing research or the like, and it is also possible to provide third parties with the result of the marketing research, thereby earning considerations from the third parties.

(5) If purchase information is distributed among two or more storages located at separate locations, the purchase information is exchanged among those storages, and all the purchase information stored in the storages is collected into at least one of the storages. As a result, even if a purchaser uses two or more types of payment service so that purchase information is stored in several different payment service providers, it is still possible to comprehensively manage the purchase information stored in the storages, thereby facilitating more extensive and accurate understanding of customer (consumer) trend.

(6) Anonymous transaction information stored in the storage means and/or information obtained based upon the anonymous transaction information are provided to third parties by return for payment. At that time, part of the payment received from the third parties is distributed to purchasers and merchants according to pre-established contracts with them.

(7) An anonymization service provider with a transaction-information-anonymizing server is paid by a payment-service-providing server side for anonymization processing. The profit may be returned to purchasers and merchants.

(8) If the transaction-information-anonymizing server receives information required to generate anonymous transaction information from the payment-service-providing server, the payment-service-providing server side is paid by the transaction-information-anonymizing server side for the offering of the required information.

(9) Since a merchant server has a storage storing anonymous purchase information provided by a purchase-information-anonymizing server, it is possible for the merchant side to accumulate his own customers' purchase data as anonymous purchase information. It is also possible for the merchant to use the accumulated information effectively for marketing research or the like. At that time, by using a payment-service-providing server of a credit company or a financial institution as a transaction-information-anonymizing server, it is possible for a payment service provider, such as a credit card company or a financial institution, to carry out anonymization processing as part of their business, thereby earning a consideration from the merchant who requested for the anonymization service.

(10) When a purchaser visits a merchant's place and makes some purchases by credit card or debit card, the merchant uses the credit card or debit card to obtain purchase information therefrom. In the mean time, when a purchase is made between a purchaser and a merchant over a communications network, the merchant receives purchase information from a purchaser terminal via the communications network. Accordingly, it is possible for the merchant to easily obtain purchase information relating to commercial transactions made with purchasers.

(11) A form of anonymous personal information, which complies with a pre-established contract with a purchaser, is generated according to purchase information, and uses the generated anonymous personal information as the anonymous purchase information. Hence, varying anonymity levels, raging from no anonymization to complete anonymity, can be guaranteed at the anonymization of the personal information. At that time, use of an anonymous personal information table, which stores customer identification information of purchasers and their anonymous personal information in association with one another, significantly facilitates the processing of anonymization.

(12) A huge amount of purchase information relating to commercial transactions between purchasers and merchants is accumulated as anonymous purchase information from which the identities of the merchants will never be revealed, and the accumulated anonymous purchase information has great significance in marketing research (consumers'trend research) or the like. Hence if employed in an electronic payment system in combination with SET, it is possible to make the best use of the market value of the purchase information of the merchants while protecting their privacy. At that time, a form of anonymous merchant information, which complies with a pre-established contract with the merchant, is generated according to purchase information, and the generated anonymous merchant information is used as the anonymous purchase information. Hence, varying anonymity levels, raging from no anonymization to complete anonymity, can be guaranteed at the anonymization of the merchant information. Moreover, use of an anonymous merchant information table, which stores merchant identification information of merchants and their anonymous merchant information in association with one another, significantly facilitates the processing of anonymization.

Other objects and further features of the present invention will be apparent from the following detailed description when read in conjunction with the accompanying drawings.

### BRIEF DESCRIPTION OF THE DRAWINGS

FIG. 1 is a block diagram schematically showing an electronic payment system to which a transaction information management system of a first embodiment of the present invention is applied;

FIG. 2 is a view for describing procedures executed in the electronic payment system (transaction information management system) of the first embodiment;

FIG. 3 is a block diagram schematically showing an electronic payment system to which a transaction information management system of a second embodiment of the present invention is applied;

FIG. 4 is a view for describing procedures executed in the electronic payment system (transaction information management system) of the second embodiment;

FIG. 5 is a block diagram schematically showing an electronic payment system to which a transaction information management system of a third embodiment of the present invention is applied;

FIG. 6 is a view for describing procedures executed in the electronic payment system (transaction information management system) of the third embodiment;

FIG. 7 is a block diagram schematically showing an electronic payment system to which a transaction information management system of a fourth embodiment of the present invention is applied;

FIG. 8 is a view for describing procedures executed in the electronic payment system (transaction information management system) of the fourth embodiment;

FIG. 9 is a block diagram schematically showing an electronic payment system to which a transaction information management system of a fifth embodiment of the present invention is applied; and

FIG. 10 is a view for describing SET™ in the electronic payment system.

### DESCRIPTION OF THE PREFERRED EMBODIMENTS

Generally speaking, privacy must be protected in electronic payment, but some of the information used in electronic payment is not so important for customers as to be protected. Hence, let us divide the commercial transaction information into two groups: a customer's personal information and his purchase history information (including merchant information).

The customer's personal information is defined as the information from which the customer's identity is revealed. The customer's name, address, and credit card number are example of personal information. Meanwhile, the purchase history information is time-series data containing information about when, where, and what the customer purchased. Generally speaking, the former, the personal information, is registered with credit card companies or financial institutions as card holders' registration data, while the latter, the purchase history information, is accumulated at merchants or credit card companies. At that time, the purchase history information one merchant collects is limited to the information relating to commercial transaction made between customers and the merchant himself. Hence if all such information every merchant obtains at electronic payments by credit card is collected, it is possible to use the accumulated information to know who purchased what, when and where the purchase was made.

Of course such a situation would never be allowable for most customers. It would cause undesirable things, if a customer's personal information and his purchase history information should circulate and accumulate in association with one another. In a case where payment is made by credit card, it is the card number that links the above two kinds of information. In view of this, SET™ (Secure Electronic Transaction™: a trademark owned by SET Secure Electronic Transaction LLC.) properly separates the two kinds of information, so that customers' privacy can be protected to prevent the above-mentioned troubles.

Customers would feel against it, if his purchase information associated with his personal information should be stored for use in marketing. In such a case, however, if the personal information is converted in form such that customers' identities are not revealed therefrom (this process will hereinafter be called “anonymization”), that is, if the converted personal information includes only customers' attributes or the like; most customers would feel it acceptable that his purchase history with his converted (anonymized) personal information is used in marketing.

In the meantime, from a standpoint of merchants, they are reluctant to offer their online shopping data to third parties. However, if a good amount of payment is made in compensation for the offering of the data, and also if the data is converted, before the data is provided to third parties, in form such that the merchants' identities are not revealed, most of the merchants would feel it allowable that the purchase history information associated with customers' personal information is used for marketing or the like.

In view of these, if customers and merchants are given appropriate value, based on some contracts, for permission for limited publication of their purchase information, including customers' personal information and merchant information, it becomes possible to provide a new electronic payment system which allows limited use of such purchase information, thereby realizing good use of the purchase information, and which also protects the customers' and the merchants' privacy.

Such an electronic payment system will probably be operated by a credit card company. With this system, it is possible for the company to accumulate a huge amount of purchase information, which has great significance in marketing research, according to a pre-established contract including a guarantee of privacy. Further, it is also possible for the company to sell the accumulated information itself or an analysis of the information to third party, thereby obtaining some profit, if the agreement has previously been made in the contract.

Paying attention to this, it is an object of the present invention to provide a way to make the best use of the commercial value of purchase information of customers while protecting their privacy.

[1] First Embodiment:

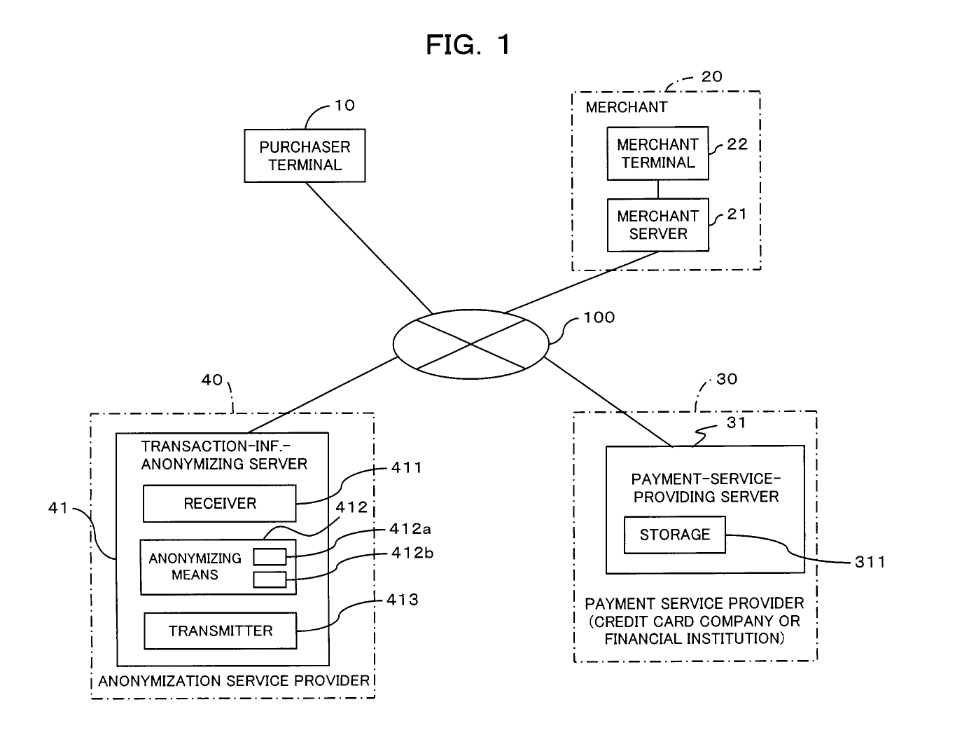

FIG. 1 shows an electronic payment system to which a transaction information management system of a first embodiment of the present invention is applied. The electronic payment system of the first embodiment, as shown in FIG. 1, employs the transaction information management system of the present invention, which manages transaction information about commercial transactions made between purchasers and merchants 20, and the system also employs SET. The electronic payment system involves a purchaser terminal 10, a merchant 20, a payment service provider 30, an anonymization service provider 40, and a communications network 100.

At the merchant 20, there are provided a merchant server 21 and a merchant terminal 22. At the credit card company 30 and the anonymization service provider 40, there are provided a payment-service-providing server 31 and a transaction-information-anonymizing server 41, respectively. These purchaser terminal 10, merchant server 21, payment-service-providing server 31, and transaction-information-anonymizing server 41 are interconnected with one another across a communications network 100 such as the Internet.

The payment-service-providing server 31 of the payment service provider 30 is communicably connected with the merchant server 21 via the communications network 100 to provide an electronic payment service where payment is made from a purchaser to the merchant 20 for a commercial transaction. A credit card company is an example of the payment service provider 30. Such a credit card company previously contracts a purchaser and a merchant to provide payment service by paying the merchant on behalf of the purchaser, allowing credit to the purchaser according to the pre-established contracts made between the credit company and the purchaser and the merchant. In addition, a financial institution, such as a bank, is another example of the payment service provider 30. Such a financial institution contracts a purchaser and a merchant previously to provide payment service by paying the merchant from the purchaser's account according to the pre-established contracts made between the financial institution and the purchaser and the merchant.

The payment-service-providing server 31 has a storage 311 storing anonymous transaction information, which has been generated by an anonymizing means 412 (described later) of the transaction-information-anonymizing server 41. The anonymous transaction information accumulates in the storage 311, thereby creating a database. The storage 311 may be an internal storage device, or otherwise, may be an external storage device, equipped to the payment-service-providing server 31.

The merchant server 21 and the merchant terminal 22 of the merchant 20 serve as obtaining means for obtaining transaction information (also called “purchase information” in this description) about commercial transactions made between purchasers and the merchant.

A purchaser accesses the merchant server 21 of the merchant 20 from the purchaser terminal 10 via a communications network 100, and makes an online purchase—asking for a product or service offered by the merchant 20—. The merchant server 21 receives a purchase order and a payment instruction, as the aforementioned purchase information, from the purchaser terminal 10. The merchant server 21 then transmits the purchase order to the payment-service-providing server 31 over the communications network 100, and additionally, it transmits the purchase order and the payment instruction themselves or customer identification information (hereinafter called “customer ID”) and merchant identification information (hereinafter called “merchant ID”), both of which are obtained from the purchase order and the payment instruction, to the transaction-information-anonymizing server 41. In other words, the merchant server 21 serves as an obtaining means for obtaining purchase information.

In another case, a purchaser visits a merchant's place and makes some purchases by credit card or debit card. A merchant terminal 22 reads data from the credit card or the debit card, thereby obtaining a customer ID or the like as purchase information. The merchant server 21 then transmits the purchase information obtained by the merchant terminal 22, including the customer ID, to the payment-service-providing server 31 and the transaction-information-anonymizing server 41. In other words, the merchant terminal 22 also serves as a obtaining means for obtaining purchase information.

The transaction-information-anonymizing server 41 of the anonymization service provider 40 has a receiver 411, an anonymizing means 412, and a transmitter 413. The receiver 411 receives purchase information from the merchant server 21 of the merchant 20 via the communications network 100. In accordance with the purchase information, which has been received by the receiver 411, the anonymizing means 412 generates anonymous purchase information from which the identities of the customer and the merchant 20 cannot be recognized. The transmitter 413 transmits the anonymous purchase information, which has been obtained by the anonymizing means 412, to the payment-service-providing server 31 via the communications network 100, and the anonymous purchase information is accumulated in the storage 311.

Here, on the basis of the purchase information received from the merchant 20, the anonymizing means 412 generates a form of anonymous personal information which complies with a pre-established contract with the purchaser, and then outputs the generated anonymous personal information as anonymous purchase information. Moreover, on the basis of the purchase information received from the merchant 20, the anonymizing means 412 also generates a form of anonymous merchant information which complies with a pre-established contract with the merchant, and then outputs the generated anonymous merchant information as anonymous purchase information.

Particularly, an anonymizing means 412 of the present embodiment has an anonymous personal information table 412a that stores purchasers' IDs in association with their anonymous personal information, which complies with pre-established contracts with the individual purchasers. The anonymizing means 412 extracts a customer ID contained in object purchase information, and then reads out the anonymous personal information which is stored in the anonymous personal information table 412a in association with the extracted customer ID. The read-out anonymous personal information is output as anonymous purchase information.

Further, the anonymizing means 412 of the present embodiment has an anonymous merchant information table 412b that stores merchants' IDs in association with their anonymous merchant information, which complies with pre-established contracts with the individual merchant. The anonymizing means 412 extracts a merchant ID contained in object purchase information, and then reads out the anonymous merchant information which is stored in the anonymous merchant information table 412b in association with the extracted merchant ID. The read-out anonymous merchant information is output as anonymous purchase information.

The anonymous personal information registered in the anonymous personal information table 412a and the anonymous merchant information registered in the anonymous merchant information table 412b will be detailed later.

The payment service provider 30, such as a credit card company or a financial institution which operates a system of the present embodiment, holds pre-established contracts with purchasers and merchants 20. The contracts allow the payment service provider 30 to sell third parties the purchase information itself in a storage 311 and an analysis of the purchase information for marketing research, thereby making profits.

Part of the thus-obtained profits is distributed to the purchasers according to the pre-established contracts between the payment service provider 30 and the individual purchasers in the form of, for example, cash, a discount on a membership due, or a discount on purchases.

Likewise, part of the thus-obtained profits is distributed also to the merchants 20 according to the pre-established contracts between the payment service provider 30 and the individual merchants 20 in the form of, for example, cash or a discount on percentage fees.

Further, the payment service provider 30 pays the anonymization service provider 40 for the anonymization processing (data conversion service) carried out by the anonymizing means 412. On the other hand, if the payment service provider 30 provides the transaction-information-anonymizing server 41 with personal information required for the anonymization processing, the anonymization service provider 40 pays the payment service provider 30 for the providing of the information.

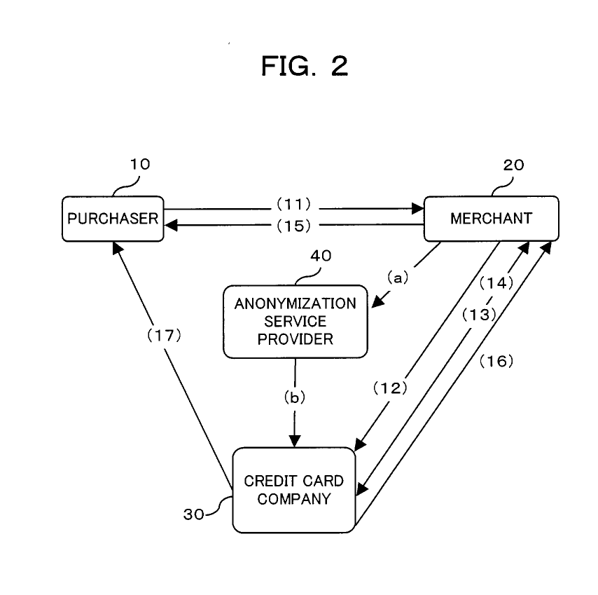

Referring now to FIG. 2, a description will be made hereinbelow of electronic payment procedures and purchase information management procedures in an electronic payment system of the first embodiment. More precisely, the electronic payment process follows the under-mentioned procedures (11) through (17); the purchase information management process follows the under-mentioned procedures (a) and (b). Note that arrows (11) through (17) in FIG. 2 denote procedures (11) though (17), respectively, and also note that arrows (a) and (b) denote procedures (a) and (b), respectively.

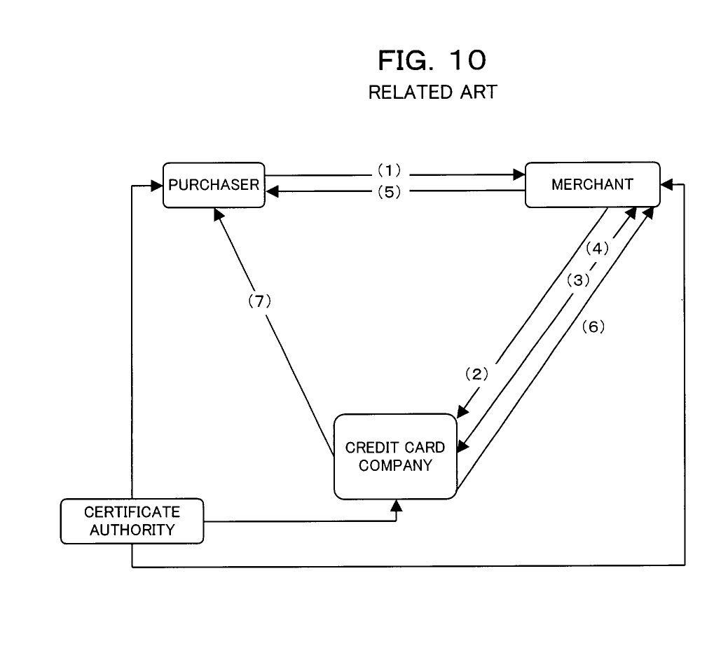

Here, electronic payment procedures (11) through (17) are basically approximate to the aforementioned procedures (1) through (7) in SET, which were described with reference to FIG. 10.

(11) A purchaser (cardholder) places an online order, from a purchaser terminal, with a merchant 20 for a product or service. A purchase order and a payment instruction are transmitted from the purchaser terminal 10 to a merchant server 21 of the merchant 20.

(12) The merchant server 21 of the merchant 20 sends the payment instruction to a payment service provider 30 (a credit card company, for example, in this description).

(13) The merchant server 21 of the merchant 20 contacts the credit card company 30 to check that the purchaser has sufficient funds or credit to make the purchase.

(14) The credit card company 30 sends a reply message (authorization) in response to the inquiry made in the above procedure (13).

(15) Assuming the authorization in the above procedure (14) has been confirmed, the merchant 20 delivers the purchase to the purchaser.

(16) The credit card company 30 deposits the payment to the merchant.

(17) The credit company 30 bills the purchaser for the payment.

The foregoing SET electronic payment system, according to the first embodiment, includes the anonymization service provider 40 as well as the customer, the merchant 20, and the credit card company. The anonymization service provider 40 is not involved in an electronic payment itself, but it collects required information throughout the payment processing to generate anonymous purchase information. Further, in the first embodiment, managing and accumulating the purchase information are performed following the below two procedures (a) and (b).

(a) The merchant server 21 of the merchant 20 obtains purchase information including the payment instruction and the purchase order in the forgoing step (11) (obtaining step), and then transmits the set of the payment instruction and the purchase order to the transaction-information-anonymizing server 41 of the anonymization service provider 40. At that time, as aforementioned, a customer ID and a merchant ID may be extracted from the payment instruction and the purchase order to be transmitted, and the extracted IDs are sent to the anonymization service provider 40.

(b) Upon receipt of the purchase information (the payment instruction/purchase order themselves, or the customer ID/merchant ID) from the merchant 20, the transaction-information-anonymizing server 41 of the anonymization service provider 40 performs anonymization processing according to the purchase information (anonymizing step). At that time, when receiving the payment instruction/purchase order themselves, the anonymizing means 412 performs anonymizing processing on the received payment instruction/purchase order, in accordance with pre-established contracts with the customer and the merchant 20, thereby generating anonymous purchase information. If the anonymizing means 412 has the aforementioned anonymous personal information table 412a and anonymous merchant information table 412b, the anonymizing means 412 extracts a customer ID and a merchant ID from the purchase information. The anonymizing means 412 reads, from the anonymous personal information table 412a and the anonymous merchant information table 412b, anonymous personal information associated with the extracted customer ID and anonymous merchant information associated with the extracted merchant ID, respectively, thereby obtaining the anonymous personal information and the anonymous merchant information as anonymous purchase information. The thus-obtained anonymous purchase information is transmitted from a transmitter 413 to a payment-service-providing server 31 of the credit card company 30 via a communications network 100, and is stored in a storage 311 (storing step).

As in the foregoing, the anonymization involves two kinds of information: a purchaser's personal information; and a merchant information. The personal information includes information from which the purchaser's identity can be revealed: for example, a credit card number; and the name, address, telephone number, sex, date of birth, and employment, of a purchaser. In the meantime, the merchant information includes information from which the identities of the merchant and transactions can be specified: for example, a merchant ID (merchant identification information), company name; the name and address of a merchant; and a transaction date.

The anonymization service provider 40 makes such personal information and merchant information anonymous, thereby generating anonymous personal information and anonymous merchant information. The anonymous personal information (registered in the anonymous personal information table 412a) includes the district of a purchaser's residence (the name of the city, town, or village), and the age group, sex, and occupation, of the purchaser. The anonymous merchant information (registered anonymous merchant information table 412b) includes, for example, the business category and the size of a merchant company, the district of a merchant place, and the date of a transaction.

The anonymization service provider 40 has an anonymous personal information table 412a and an anonymous merchant in formation table 412b. These tables previously store customers' credit card numbers (customer IDs) in association with anonymous personal information generated from the customers' personal information, and merchant IDs in association with anonymous merchant information, respectively. Upon receipt of a set of the payment instruction and the purchase order, which has been sent in the procedure (a), the anonymization service provider 40 extracts the credit card number and the merchant ID contained in the set. On the basis of the extracted credit card number, the extracted merchant ID, and information previously provided by the credit card company 30, the anonymization service provider 40 converts the personal information and the merchant information into anonymous personal information and anonymous merchant information, respectively, and then transmits the thus obtained anonymous personal information and anonymous merchant information to the credit card company 30.

As a result, purchase information is accumulated in the storage 311 of the present system in anonymous form that complies with a pre-established contract, so that the privacy of purchasers and merchants 20 can be protected.

What is included in such anonymous purchase information has previously been specified based on a contract between the credit card company 30 and each purchaser or merchant 20. The degree of anonymization to be performed on original purchase information depends upon this contract, ranging from no anonymization to complete anonymity of the purchaser or the merchant 20.

With the foregoing system, it is possible for the credit company 30 to accumulate a large amount of anonymous purchase information without impairing privacy. Moreover, assuming that pre-established contracts with purchasers permit the selling of such purchase information or an analysis of the purchase information, the credit card company 30 can sell the information, thereby producing profits from the information. The credit card company 30 returns part of the profits to the purchaser in the form of cash, a discount on a membership due, or a discount on purchases, and it also returns other part of the profits to the merchant 20 in the form of cash or a discount on percentage fees. Further, the payment service provider 30 pays an anonymization service provider 40 for data conversion service (anonymization processing).

The system of the first embodiment is applicable not only in online shopping but also in ordinary shopping where purchasers visit merchants' places to make purchases. In the latter case, the following procedure (11)′ is carried out in place of the above procedure (11).

(11)′ A purchaser expresses his will to purchase a product or service. The merchant 20 prepares a purchase order including product information and a payment instruction including a credit card number, in electronic form, on behalf of the purchaser. The prepared purchase order and payment instruction are input from a merchant terminal 22 to a merchant server 21.

Here, it is assumed that, as in the case of SET, online parts (particularly between the merchant server 21 and the transaction-information-anonymizing server 41) of the system of the first embodiment employs authorization, cryptography, and digital signature technologies to guarantee the security of the system.

With the first embodiment of the present invention, purchase information relating to commercial transactions between purchasers and merchants 20 is accumulated, as anonymous purchase information from which the identities of the purchasers and the merchants will never be revealed, in the storage 311 of the payment service provider 30, and the accumulated anonymous purchase information has great significance in marketing research or the like. Hence if the present embodiment is employed in an electronic payment system in combination with SET, it is possible to make the best use of the market value of the purchase information of purchasers and merchants 20 while protecting their privacy.

At that time, an anonymization service provider 40 carries out anonymization of the purchase information as their business in return for payment by a company (the credit card company 30 in the first embodiment) that requested the anonymization service.

Further, the payment service provider 30 has the storage 311 storing purchase information received from a transaction-information-anonymizing server 41. It is thus possible for such a payment service provider, such as a credit card company or a financial institution, to effectively use the stored information for marketing research or the like, and it is also possible to provide the result of the marketing research to third parties in return for payment.

When anonymous purchase information is generated, personal information and merchant information are converted in form such that they comply with pre-established contracts held with every purchaser and merchant. Hence, varying anonymity levels, raging from no anonymization to complete anonymity of the purchasers and the merchants 20, can be guaranteed at the anonymization of the personal information and the merchant information.

At that time, use of an anonymous personal information table 412a, which stores customer IDs associated with anonymous personal information, and an anonymous merchant information table 412b, which stores merchant IDs associated with anonymous merchant information, significantly facilitates the anonymization processing.

[2] Second Embodiment:

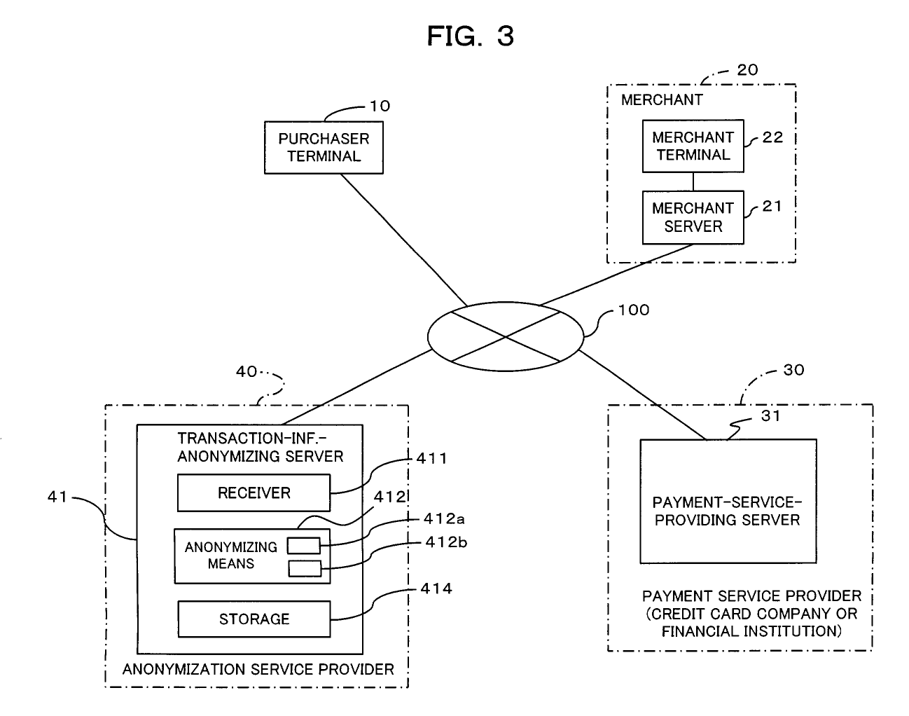

FIG. 3 shows an electronic payment system to which a transaction information management system of a second embodiment of the present invention is applied. The electronic payment system of the second embodiment, as shown in FIG. 3, has a construction similar to that of an electronic payment system of the first embodiment except that a storage 414 is provided at a transaction-information-anonymizing server 41 of an anonymization service provider 40 instead of a storage 311, which was provided at a payment-service-providing server 31 in the first embodiment. In addition, the second embodiment has no transmitter 413, which was provided at the anonymization service provider 40 in the first embodiment. In FIG. 3, like reference numbers to those that have already been described designate similar parts or elements, so their detailed description is omitted here.

In the second embodiment, it is the anonymization service provider 40 that accumulates anonymous purchase information. Hence it is also the anonymization service provider 40 that enjoys the profit the anonymous purchase information produces. In this case, distribution of the profit to purchasers and merchants 20 is carried out by the anonymization service provider 40, and the anonymization service provider 40 also pays the credit card company 30 for the providing of information.

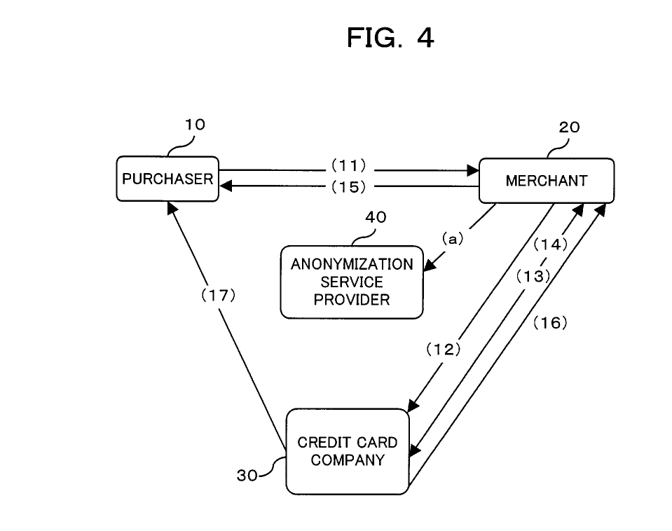

Referring now to FIG. 4, a description will be made hereinbelow of electronic payment procedures and purchase information management procedures in an electronic payment system of the second embodiment. Electronic payment procedures (11) through (17) of the second embodiment are the same as those that were described with reference to FIG. 2, so their detailed description is omitted here. Additionally, as to the purchase information management, after procedure (a), which was described with reference to FIG. 2, procedure (b), which was also described with reference to FIG. 2, is performed within a transaction-information-anonymizing server 41. Note that arrows (11) through (17) and arrow (a) in FIG. 4 denote procedures (11) though (17) and procedure (a), respectively.

Here, the following description will concentrate on the management and accumulation of purchase information.

(a) A merchant server 21 of a merchant 20 obtains purchase information including a payment instruction and a purchase order in the forgoing step (11) (obtaining step), and then transmits the set of the payment instruction and the purchase order to the transaction-information-anonymizing server 41 of the anonymization service provider 40. At that time, as aforementioned, a customer ID and a merchant ID may be extracted, as purchase information, from the payment instruction and the purchase order, and then transmitted to the anonymization service provider 40.

Upon receipt of the purchase information (the payment instruction/purchase order themselves, or the customer ID/merchant ID) from the merchant 20, the transaction-information-anonymizing server 41 of the anonymization service provider 40 performs anonymization processing according to the purchase information (anonymizing step). At that time, in a case where the payment instruction/purchase order themselves are received, the anonymizing means 412 performs anonymizing processing on the received payment instruction/purchase order, in accordance with pre-established contracts with the customer and the merchant 20, thereby generating anonymous purchase information. If the anonymizing means 412 has the aforementioned anonymous personal information table 412a and anonymous merchant information table 412b, the anonymizing means 412 extracts a customer ID and a merchant ID from the purchase information. The anonymizing means 412 reads anonymous personal information associated with the extracted customer ID and anonymous merchant information associated with the extracted merchant ID, from the anonymous personal information table 412a and the anonymous merchant information table 412b, respectively, thereby obtaining the anonymous personal information and the anonymous merchant information as anonymous purchase information. The thus-obtained anonymous purchase information is accumulated in a storage 414 (storing step).

As a result, the second embodiment guarantees similar effects and profits to those that were realized in the first embodiment. Additionally, since the transaction-information-anonymizing server 41 has the storage 414 accumulating anonymous purchase information therein, it is possible for the anonymization service provider 40 to provide third parties with the accumulated anonymous purchase information itself and/or any information obtained from the anonymous purchase information, as a result of marketing research, thereby earning considerations from the third parties.

[3] Third Embodiment:

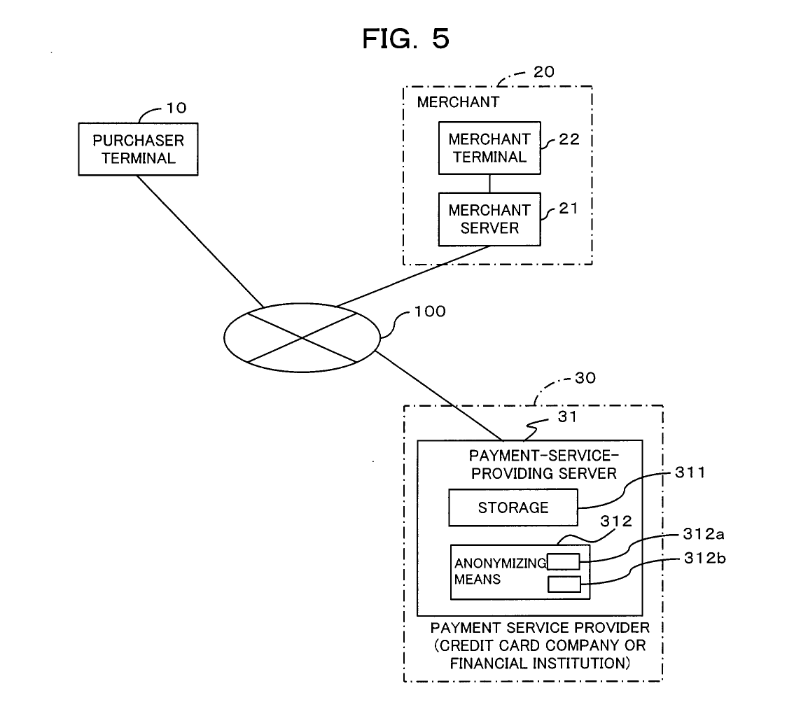

FIG. 5 shows an electronic payment system to which a transaction information management system of a third embodiment of the present invention is applied. In the electronic payment system of the third embodiment, as shown in FIG. 5, a payment-service-providing server 31 serves also as a transaction-information-anonymizing server 41 of the second embodiment.

More concretely, an anonymization service provider 40 is omitted in the third embodiment, and a payment-service-providing server 31 is provided with a storage 311 as in the case of the second embodiment. The third embodiment also includes an anonymizing means 312, which corresponds to an anonymizing means 412 of the first embodiment. The anonymizing means 312 of the third embodiment includes an anonymous personal information table 312a and an anonymous merchant information table 312b, which correspond to an anonymous personal information table 412a and an anonymous merchant information table 412b, respectively, of the first embodiment.

In cases where a credit card company 30 carries out the functions of an anonymization service provider, it is required that the credit card company 30 previously contracts the purchasers to protect their privacy.

Here, in FIG. 5, like reference numbers to those that have already been described designate similar parts or elements, so their detailed description is omitted here.

A merchant server 21 and a merchant terminal 22 of the third embodiment, as in the case of the first embodiment, serves as an obtaining means for obtaining purchase information (transaction information) relating to commercial transactions made between the merchant and purchasers.

When a purchaser made an online purchase with a merchant 20 on a purchaser terminal 10, the merchant server 21, as in the case of the first embodiment, receives a purchase order and a payment instruction, as purchase information, from the purchaser terminal 10. The merchant server 21 of the third embodiment then transmits both of the purchase order and the payment instruction to the payment-service-providing server 31 over a communications network 100.

When a purchaser decides to make a purchase with a credit card or a debit card at a merchant 20, a merchant terminal 22 reads data from the credit card or the debit card, as in the case of the first embodiment, thereby obtaining a customer ID or the like as purchase information. The merchant server 21 of the third embodiment then transmits the purchase information, including the customer ID, obtained by the merchant terminal 22, to the payment-service-providing server 31 over the communications network 100.

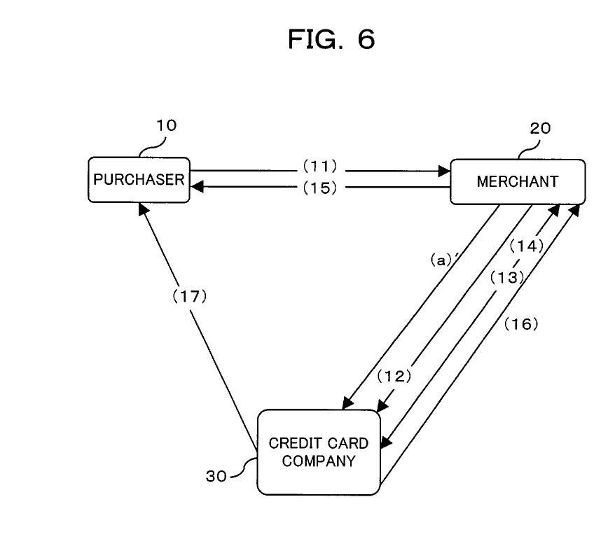

Referring now to FIG. 6, a description will be made hereinbelow of electronic payment procedures and purchase information management procedures in an electronic payment system of the third embodiment. Electronic payment procedures (11) through (17) of the third embodiment are the same as those that were described with reference to FIG. 2, so their detailed description is omitted here. Additionally, as to the purchase information management, after the merchant 20 executes procedure (a)′, which is almost the same as procedure (a) that was described with reference to FIG. 2, for a credit card company 30, procedure (b), which was described with reference to FIG. 2, is performed within a payment-service-providing server 31. Note that arrows (11) through (17) and arrow (a)′ in FIG. 6 denote procedures (11) though (17) and procedure (a)′, respectively.

Here, the following description will concentrate on the purchase information management and accumulation procedure (a)′.

(a)′ The merchant server 21 of the merchant 20 obtains the purchase information including the payment instruction and the purchase order in the forgoing step (11) (obtaining step), and then transmits the set of the payment instruction and the purchase order to the payment-service-providing server 31 of the credit card company 30. At that time, as aforementioned, a customer ID and a merchant ID may be extracted, as purchase information, from the payment instruction and the purchase order, and then transmitted to the credit card company 30.

Upon receipt of the purchase information (the payment instruction/purchase order themselves, or the customer ID/merchant ID) from the merchant 20, the payment-service-providing server 31 of the credit card company 30 performs anonymization processing according to the purchase information (anonymizing step). At that time, when receiving the payment instruction/purchase order themselves, the anonymizing means 312 performs anonymizing processing on the received payment instruction/purchase order, in accordance with pre-established contracts with the customer and the merchant 20, thereby generating anonymous purchase information. If the anonymizing means 312 has the aforementioned anonymous personal information table 312a and anonymous merchant information table 312b, the anonymizing means 312 extracts a customer ID and a merchant ID from the purchase information. The anonymizing means 312 reads anonymous personal information associated with the extracted customer ID and anonymous merchant information associated with the extracted merchant ID, from the anonymous personal information table 312a and the anonymous merchant information table 312b, respectively, thereby obtaining the anonymous personal information and the anonymous merchant information as anonymous purchase information. The thus-obtained anonymous purchase information is accumulated in a storage 311 (storing step).

As a result, the third embodiment guarantees similar effects and profits to those that were realized in the first and second embodiments. Additionally, since the payment-service-providing server 31 of a credit company or a financial institution has the anonymizing means 312 and the storage 311, it is possible for the payment service provider (the credit card company or the financial institution) to anonymize the purchase information within its own server 31, without necessity for paying any compensation for the anonymization processing, and the generated anonymous purchase information is accumulated in the server 31. It is thus possible for the payment service provider to effectively use the accumulated information for marketing research or the like, and it is also possible to provide third parties with the result of the marketing research, thereby earning considerations from the third parties.

[4] Fourth Embodiment:

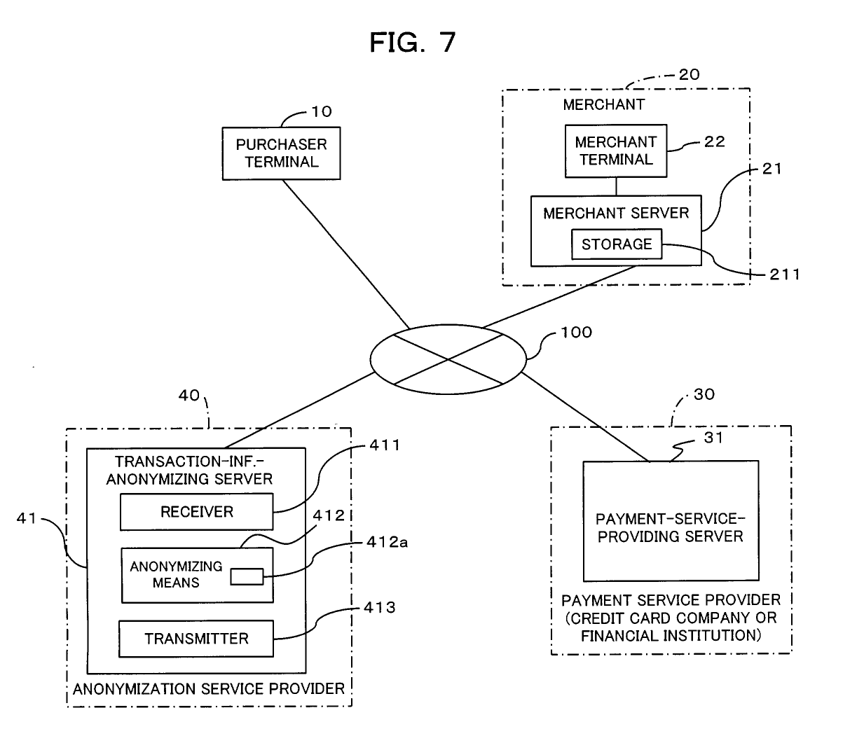

FIG. 7 shows an electronic payment system to which a transaction information management system of a fourth embodiment of the present invention is applied. The electronic payment system of the fourth embodiment, as shown in FIG. 7, has a construction similar to that of an electronic payment system of the first embodiment except that a storage 211 is provided at a merchant server 21 of a merchant 20 instead of a storage 311, which was provided at a payment-service-providing server 31 in the first embodiment. The storage 211 may be an internal storage device equipped in the merchant server 21, or otherwise, it may an external storage device provided to the merchant server 21. In FIG. 7, like reference numbers to those that have already been described designate similar parts or elements, so their detailed description is omitted here.

Most merchants (convenience stores or the like) of today collets purchase data, using a POS system or the like, of purchases made at the stores of their own. In that case, however, since customers' personal information is collected by store clerks, the collected information depends on the store clerks' judgment and their inputting of data, thus lacking validity. In a case of online shopping where SET is employed, merchants cannot obtain any personal information of their customers, failing to accumulate any purchase information.

In view of these, in the fourth embodiment, the storage 211 at the merchant 20 accumulates anonymous purchase information received from a transaction-information-anonymizing server 41. Such purchase information to be accumulated in the storage 211 of each merchant 20 is limited to the information about purchases that are made at the merchant 20. In this case, the merchant 20 pays an anonymization service provider 40 for anonymization processing. Further, the anonymization service provider 40 pay a credit card company 30 for the information required for the anonymization processing, if such information is provided from the credit card company 30 to the transaction-information-anonymizing server 41.

In the fourth embodiment, as in the third embodiment, the payment-service-providing server 31 may carry out the functions of the transaction-information-anonymizing server 41; that is, the credit card company 30 serves also as the anonymization service provider 40. In that case, it is required that contracts are previously held between purchasers and the credit card company 30 such that the privacy of purchasers are protected.

As in the case of the first embodiment, each of the merchant server 21 and the merchant terminal 22 of the fourth embodiment serves as obtaining means for obtaining purchase information about commercial transactions made between the merchant 20 and purchasers. When a purchaser made an online purchase with a merchant 20 on a purchaser terminal 10, the merchant server 21 receives a purchase order and a payment instruction, as purchase information, from the purchaser terminal 10. The merchant server 21 then transmits the purchase order to the payment-service-providing server 31 over the communications network 100. Additionally, the merchant server 21 also transmits the purchase order and the payment instruction themselves or a customer ID which is obtained from the purchase order and the payment instruction, to the transaction-information-anonymizing server 41. In the meantime, when a purchaser visits a merchant's place and makes some purchases by credit card or debit card, a merchant terminal 22 reads data from the credit card or the debit card, thereby obtaining a customer ID or the like as purchase information. The merchant server 21 then transmits the purchase information obtained by the merchant terminal 22, including the customer ID, to the payment-service-providing server 31 and the transaction-information-anonymizing server 41 over the communications network 100.

Further, in the fourth embodiment, the merchant 20 accumulates purchase information, which is limited to the information about the purchases that were made with the merchant 20. The transaction-information-anonymizing server 41 should anonymize the purchase information in terms of purchasers' personal information, but not in terms merchant information. Hence, the transaction-information-anonymizing server 41 requires only an anonymous personal information table 412a, without necessity for an anonymous merchant information table 412b.

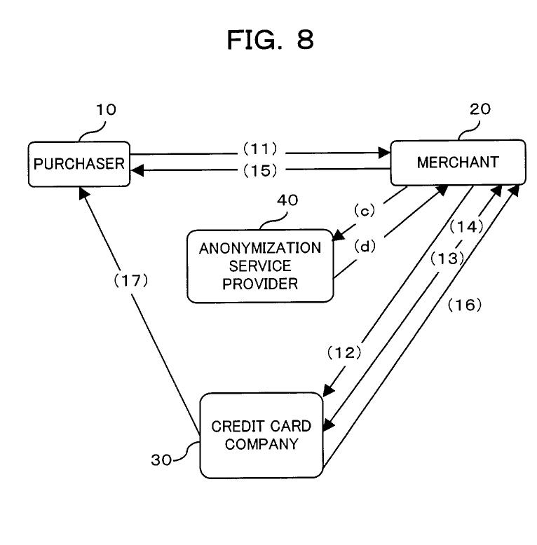

Referring now to FIG. 8, a description will be made hereinbelow of electronic payment procedures and purchase information management procedures in an electronic payment system of the fourth embodiment. Electronic payment procedures (11) through (17) of the fourth embodiment are the same as those that were described with reference to FIG. 2, so their detailed description is omitted here. Additionally, as to the purchase information management according to the fourth embodiment, procedures (a) and (b) of the first embodiment are replaced by the following procedures (c) and (d). Note that arrows (11) through (17) and arrows (c) and (d) in FIG. 8 denote procedures (11) though (17) and procedures (c) and (d), respectively.

(c) The merchant server 21 of the merchant 20 obtains a payment instruction as purchase information (obtaining step) in procedure (11). The payment instruction is transmitted to the transaction-information-anonymizing server 41 of the anonymization service provider 40. At this time, as in the foregoing, a customer ID may be extracted from the payment instruction and then transmitted to the anonymization service provider 40 as purchase information.

(d) Upon receipt of the purchase information (the payment instruction itself or the customer ID) from the merchant 20, the transaction-information-anonymizing server 41 of the anonymization service provider 40 performs anonymization processing according to the purchase information (anonymizing step). At that time, in a case where the payment instruction itself is received, the anonymizing means 412 performs anonymizing processing on the received payment instruction in accordance with a pre-established contract held with the purchaser, thereby generating anonymous purchase information. If the anonymizing means 412 has the aforementioned anonymous personal information table 412a, the anonymizing means 412 extracts a customer ID from the purchase information, and then reads out anonymous personal information associated with the extracted customer ID from the anonymous personal information table 412a, thereby obtaining the anonymous personal information as anonymous purchase information. The thus-obtained anonymous purchase information is transmitted to the merchant server 21 of the merchant 20 over the communications network 100, and is accumulated in a storage 211 (storing step).

As a result, the merchant 20 accumulates his own customers' personal information that has been anonymized according to a pre-established contract in the storage 211. It is thus possible for the merchant 20 to use the accumulated information for marketing research or the like.

At that time, the anonymization service provider 40 carries out the anonymization of the purchase information as their business in return for payment by a merchant who requested the anonymization service. Moreover, by using a payment-service-providing server 31 of a credit company or a financial institution as the transaction-information-anonymizing server 41, it is possible for a payment service provider, such as a credit card company or a financial institution, to carry out the anonymization processing as part of their business, thereby earning a consideration.

[5] Fifth Embodiment:

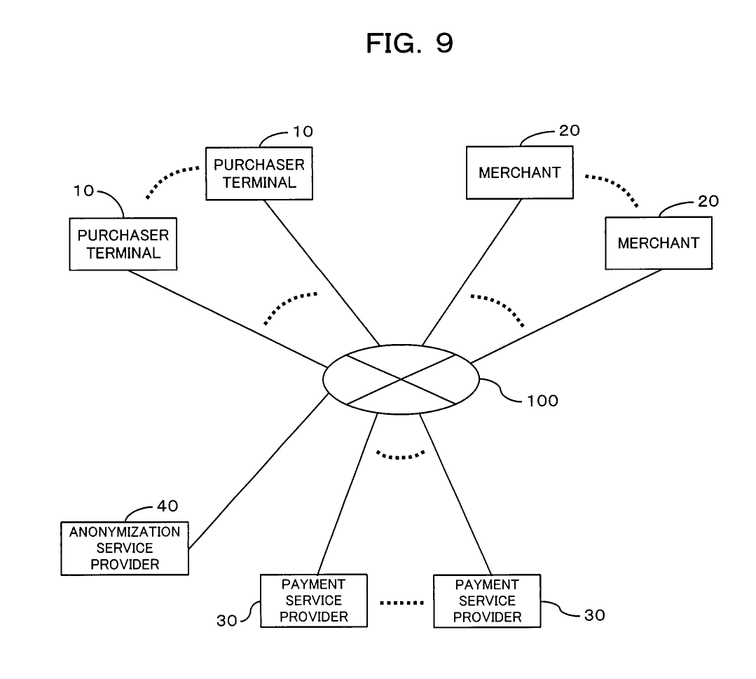

FIG. 9 shows an electronic payment system to which a transaction information management system of a fifth embodiment of the present invention is applied. In the first through fourth embodiments, as shown in FIGS. 1 though 8, there is provided one each of the purchaser terminal 10, merchant 20, credit card company 30, and anonymization service provider 40. In the fifth embodiment, however, as shown in FIG. 9, two or more each of the purchaser terminal 10, merchant 20, and credit card company 30, and those are communicably interconnected one another. Further, although a single anonymization service provider 40 is provided in this description, there may otherwise be provided two or more anonymization service providers 40.

In the fifth embodiment, each payment service provider (credit card company) 30 has a storage 311 (not shown in FIG. 9; see FIG. 1 or FIG. 5), and the anonymization service provider 40 has a storage 414 (not shown in FIG. 9; see FIG. 3). At that time, at least one of the payment service providers 30 may serve also as the anonymization service provider 40.

In this manner, the storages, 311 and 414, are located at two or more separate locations, and anonymous purchase information is exchanged among those storage, 311 and 414. Additionally, the fifth embodiment includes a means for colleting and accumulating all the anonymous transaction information into at least one of those storages (for example, the storage 414 of the anonymization service provider 40). Such a means can be realized by, for example, a transaction-information-anonymizing server 41 (not shown in FIG. 9) of the anonymization service provider 40.

As a result, the fifth embodiment guarantees similar effects and profits to those that were realized in the first through third embodiments. Additionally, the purchase information is distributed among the storages, 311 and 314, located at separate locations, and the purchase information is exchanged among the storages, 311 and 314, and all the purchase information stored in the storages, 311 and 314, is collected into at least one of the storages, 311 and 314.

As a result, even if a purchaser uses two or more types of payment service (two or more credit card companies and financial institutions) so that purchase information is stored in several different payment service providers, it is still possible to comprehensively manage the purchase information stored in the storages, 311 and 414, thereby facilitating more extensive and accurate understanding of the trend of customers (consumers).

[6] Other Modifications:

Further, the present invention should by no means be limited to the above-illustrated embodiments, and various changes or modifications may be suggested without departing from the gist of the invention.

For example, in the foregoing embodiments, the purchaser terminal 10, merchant server 21, payment-service-providing server 31, and transaction-information-anonymizing server 41 are connected via a common network 100. The purchaser terminal 10 and the merchant server 21, and the purchaser terminal 10 and the payment-service-providing server 31, can otherwise be connected via the Internet; the merchant server 21 and the payment-service-providing server 31, and the merchant server 21 and the transaction-information-anonymizing server 41, and the payment-service-providing server 31 and the transaction-information-anonymizing server 41, can otherwise be connected via dedicated lines.

What is claimed is:

1. A system for managing transaction information about a commercial transaction made between a purchaser and a merchant, said system comprising:
obtaining means, provided at said merchant, for obtaining said transaction information;
anonymizing means for generating anonymous transaction information according to said transaction information which has been obtained by said obtaining means, said anonymous transaction information being adapted to protect said purchaser's privacy and anonymity; and
storage means for storing said anonymous transaction information which has been generated by said anonymizing means.

2. A system as recited in claim 1, further comprising a transaction-information-anonymizing server which is communicably connected, via a communications network, with said obtaining means provided at said merchant,
said anonymizing means being provided at said transaction-information-anonymizing server, and
said obtaining means transmitting said transaction information to said anonymizing means of transaction-information-anonymizing server via said communications network.

3. A system as recited in claim 2, wherein said storage means is provided at said transaction-information-anonymizing server.

4. A system as recited in claim 2, further comprising a payment-service-providing server, communicably connected with said obtaining means provided at said merchant via a communications network, for managing payment for the transaction made between said purchaser and said merchant,
said payment-service-providing server being communicably connected with said transaction-information-anonymizing server via a communications network,
said storage means being provided at said payment-service-providing server, and
the generated anonymous transaction information being transmitted from said transaction-information-anonymizing server to said payment-service-providing server via the last-named communications network, and stored in said storage means of said payment-service-providing server.

5. A system as recited in claim 1, further comprising a payment-service-providing server, communicably connected with said obtaining means provided at said merchant via a communications network, for managing payment for the transaction made between said purchaser and said merchant,
both said anonymizing means and said storage means being provided at said payment-service-providing server, and
said transaction information being transmitted from said obtaining means to said anonymizing means of said payment-service-providing server via the last-named communications network.

6. A system as recited in claim 4, wherein said payment-service-providing server belongs to a credit card company which provides payment service by paying said merchant on behalf of said purchaser while allowing credit to said purchaser based on pre-established contracts with said purchaser and said merchant.

7. A system as recited in claim 5, wherein said payment-service-providing server belongs to a credit card company which provides payment service by paying said merchant on behalf of said purchaser while allowing credit to said purchaser based on pre-established contracts with said purchaser and said merchant.

8. A system as recited in claim 6, wherein, when said purchaser makes said commercial transaction with said merchant by credit card, said obtaining means obtains said transaction information through a credit card which is presented by said purchaser.

9. A system as recited in claim 7, wherein, when said purchaser makes said commercial transaction with said merchant by credit card, said obtaining means obtains said transaction information through a credit card which is presented by said purchaser.

10. A system as recited in claim 4, wherein said payment-service-providing server belongs to a financial institution which provides payment service by paying said merchant from said purchaser's account based on pre-established contracts with said purchaser and said merchant.

11. A system as recited in claim 5, wherein said payment-service-providing server belongs to a financial institution which provides payment service by paying said merchant from said purchaser's account based on pre-established contracts with said purchaser and said merchant.

12. A system as recited in claim 10, wherein, when said purchaser makes said commercial transaction with said merchant by debit card, said obtaining means obtains said transaction information through a debit card which is presented by said purchaser.

13. A system as recited in claim 11, wherein, when said purchaser makes said commercial transaction with said merchant by debit card, said obtaining means obtains said transaction information through a debit card which is presented by said purchaser.

14. A system as recited in claim 1, wherein:
a plurality of said storage means for storing said anonymous transaction information are distributed among a plurality of locations, said plural storage means exchanging said anonymous transaction information thereamong; and
said system further comprises means for colleting and accumulating all said anonymous transaction information into at least one of said plural storage means.

15. A system as recited in claim 1, wherein said anonymous transaction information stored in said storage means and/or information obtained based upon said anonymous transaction information is provided to a third party in exchange for an amount of payment by said third party.

16. A system as recited in claim 15, wherein part of the payment received from said third party is distributed to said purchaser according to a pre-established contract with said purchaser.

17. A system as recited in claim 15, wherein part of the payment received from said third party is distributed to said merchant according to a pre-established contract with said merchant.

18. A system as recited in claim 16, wherein part of the payment received from said third party is distributed to said merchant according to a pre-established contract with said merchant.

19. A system as recited in claim 4, wherein said payment-service-providing server side pays said transaction-information-anonymizing server side for anonymization processing executed at said transaction-information-anonymizing server side.

20. A system as recited in claim 4, wherein, if said transaction-information-anonymizing server receives information which is required for generating said anonymous transaction information from said payment-service-providing server, said transaction-information-anonymizing server side pays said payment-service-providing server side for the offering of the required information.

21. A system as recited in claim 19, wherein if said transaction-information-anonymizing server receives information which is required for generating said anonymous transaction information from said payment-service-providing server, said transaction-information-anonymizing server side pays said payment-service-providing server side for the offering of the required information.

22. A system as recited in claim 2, further comprising a merchant server which is communicably connected with said transaction-information-anonymizing server via a communications network,
said storage means being provided at said merchant server,
the generated anonymous transaction information being transmitted from said transaction-information-anonymizing server to said merchant server via the last-named communications network, and stored in said storage means of said merchant server.

23. A system as recited in claim 22, further comprising a payment-service-providing server, communicably connected with said obtaining means provided at said merchant via a communications network, for managing the payment for the transaction made between said purchaser and said merchant.

24. A system as recited in claim 23, wherein said payment-service-providing server is communicably connected with said merchant server via a communications network, and serves as said transaction-information-anonymizing server.

25. A system as recited in claim 23, wherein said payment-service-providing server belongs to a credit card company which provides payment service by paying said merchant on behalf of said purchaser while allowing credit to said purchaser based on pre-established contracts with said purchaser and said merchant.

26. A system as recited in claim 24, wherein said payment-service-providing server belongs to a credit card company which provides payment service by paying said merchant on behalf of said purchaser while allowing credit to said purchaser based on pre-established contracts with said purchaser and said merchant.

27. A system as recited in claim 25, wherein, when said purchaser makes said commercial transaction with said merchant by credit card, said obtaining means obtains said transaction information through a credit card which is presented by said purchaser.

28. A system as recited in claim 26, wherein, when said purchaser makes said commercial transaction with said merchant by credit card, said obtaining means obtains said transaction information through a credit card which is presented by said purchaser.

29. A system as recited in claim 23, wherein said payment-service-providing server belongs to a financial institution which provides payment service by paying said merchant from said purchaser's account based on pre-established contracts with said purchaser and said merchant.

30. A system as recited in claim 24, wherein said payment-service-providing server belongs to a financial institution which provides payment service by paying said merchant from said purchaser's account based on pre-established contracts with said purchaser and said merchant.

31. A system as recited in claim 29, wherein, when said purchaser makes said commercial transaction with said merchant by debit card, said obtaining means obtains said transaction information through a debit card which is presented by said purchaser.

32. A system as recited in claim 30, wherein, when said purchaser makes said commercial transaction with said merchant by debit card, said obtaining means obtains said transaction information through a debit card which is presented by said purchaser.

33. A system as recited in claim 22, wherein said merchant server side pays said transaction-information-anonymizing server side for anonymization processing executed at said transaction-information-anonymizing server side.

34. A system as recited in claim 23, wherein, if said transaction-information-anonymizing server receives information which is required for generating said anonymous transaction information from said payment-service-providing server, said transaction-information-anonymizing server side pays said payment-service-providing server side for the offering of the required information.

35. A system as recited in claim 1, further comprising a purchaser terminal which is communicably connected, via a communications network, with said obtaining means provided at said merchant,
said commercial transaction is electronically performed between said purchaser and said merchant over the last-named communications network, and
said obtaining means obtaining said transaction information from said purchaser terminal through the last-named communications network.

36. A system as recited in claim 1, wherein said anonymizing means generates a form of anonymous personal information, which complies with a pre-established contract with said purchaser, according to said transaction information, and uses the generated anonymous personal information as said anonymous transaction information.

37. A system as recited in claim 36, wherein:
said anonymizing means includes an anonymous personal information table which stores identification (ID) information and anonymous personal information of said purchaser in association with one another, said anonymous personal information complying with a pre-established contract with said purchaser; and
said anonymizing means performs the following functions of:
extracting ID information of said purchaser contained in said transaction information;
reading out anonymous personal information which is stored in said anonymous personal information table in association with the extracted ID information; and
using the read-out anonymous personal information as said anonymous transaction information.

38. A system as recited in claim 1, wherein said anonymizing means generates anonymous transaction information according to said transaction information, said anonymous transaction information being adapted to protect not only said purchaser's but also said merchant's privacy and anonymity.

39. A system as recited in claim 38, wherein said anonymizing means generates a form of anonymous merchant information, which complies with a pre-established contract with said merchant, according to said transaction information, and uses said anonymous merchant information as said anonymous transaction information.

40. A system as recited in claim 39, wherein:
said anonymizing means includes an anonymous merchant information table which stores identification (ID) information and anonymous merchant information of said merchant in association with one another, said anonymous merchant information complying with a pre-established contract with said merchant; and
said anonymizing means performs the following functions of:
extracting ID information of said merchant contained in said transaction information;
reading out anonymous merchant information which is stored in said anonymous merchant information table in association with the extracted ID information; and
using the read-out anonymous merchant information as said anonymous transaction information.

41. A server for use in a system which manages transaction information about a commercial transaction made between a purchaser and a merchant, said server comprising:
receiving means for receiving said transaction information from said merchant through a communications network; and
anonymizing means for generating anonymous transaction information according to said transaction information which has been received by said receiving means, said anonymous transaction information being adapted to protect said purchaser's privacy and anonymity.

42. A server as recited in claim 41, wherein said anonymizing means generates a form of anonymous personal information, which complies with a pre-established contract with said purchaser, according to said transaction information, and uses the generated anonymous personal information as said anonymous transaction information.

43. A server as recited in claim 42, wherein:
said anonymizing means includes an anonymous personal information table which stores identification (ID) information and anonymous personal information of said purchaser in association with one another, said anonymous personal information complying with a pre-established contract with said purchaser; and
said anonymizing means performs the following functions of:
extracting ID information of said purchaser contained in said transaction information;
reading out anonymous personal information which is stored in said anonymous personal information table in association with the extracted ID information; and
using the read-out anonymous personal information as said anonymous transaction information.

44. A server as recited in claim 41, wherein said anonymizing means generates anonymous transaction information according to said transaction information, said anonymous transaction information being adapted to protect not only said purchaser's but also said merchant's privacy and anonymity.

45. A server as recited in claim 44, wherein said anonymizing means generates a form of anonymous merchant information, which complies with a pre-established contract with said merchant, according to said transaction information, and uses said anonymous merchant information as said anonymous transaction information.

46. A server as recited in claim 45, wherein:
said anonymizing means includes an anonymous merchant information table which stores identification (ID) information and anonymous merchant information of said merchant in association with one another, said anonymous merchant information complying with a pre-established contract with said merchant; and
said anonymizing means performs the following functions of:
extracting ID information of said merchant contained in said transaction information;
reading out anonymous merchant information which is stored in said anonymous merchant information table in association with the extracted ID information; and
using the read-out anonymous merchant information as said anonymous transaction information.

47. A server as recited in claim 41, further comprising a storage means for storing said anonymous transaction information which has been generated by said anonymizing means.

48. A server as recited in claim 47, wherein said anonymous transaction information stored in said storage means and/or information obtained based upon said anonymous transaction information is provided to a third party in exchange for an amount of payment by said third party.

49. A method for managing transaction information about a commercial transaction made between a purchaser and a merchant, said method comprising the steps of:
obtaining said transaction information;
generating anonymous transaction information according to the obtained transaction information, said anonymous transaction information being adapted to protect said purchaser's privacy and anonymity; and
storing and accumulating the generated anonymous transaction information.

50. A method as recited in claim 49, wherein said anonymous transaction information, which is obtained according to said transaction information at the anonymous-transaction-information-generating step, is adapted to protect not only said purchaser's but also said merchant's privacy and anonymity.
